(19) United States
(12) Patent Application Publication
(10) Pub. No.: US 2003/0200316 A1
(43) Pub. Date: Oct. 23, 2003

(54) Server apparatus, client apparatus, contents distributing system, contents distributing program, and information processing program

(76) Inventors: Yoshimasa Isozaki, Shizuoka-ken (JP); Yutaka Hasegawa, Shizuoka-ken (JP)

Correspondence Address: HARNESS, DICKEY & PIERCE, P.L.C., P.O. BOX 828, BLOOMFIELD HILLS, MI, 48303, US

(21) Appl. No.: 10/414,769

(22) Filed: Apr. 16, 2003

(30) Foreign Application Priority Data
Apr. 18, 2002 (JP) 2002-116073

(51) Int. Cl. G06F 15/173

(52) U.S. Cl. 709/225; 709/217

(57) ABSTRACT

There is provided a server apparatus according to which a client apparatus can become aware of recommended reproducing resource settings, and hence an environment enabling optimum reproduction can easily be obtained even if a user has little knowledge. The client apparatus inspects a state of setting of reproducing resources, which is a reproduction environment of the client apparatus, creates reproduction environment setting information, and sends the reproduction environment setting information to the server apparatus along with a user ID. The server apparatus registers the received reproduction environment setting information and user ID, and a contents type suited to the reproduction environment setting information in a management database such that the reproduction environment setting information, the user ID and the contents type correspond to one another, and furthermore acquires, from an MSG table, message data MSG, which is recommendation information, for each reproducing resource determined by the received reproduction environment setting information, and sends this message data MSG back to the client apparatus.

### BACKGROUND OF THE INVENTION

1. Field of the Invention

The present invention relates to a server apparatus, a client apparatus, a contents distributing system, a contents distributing program, and an information processing program, which are involved with the distribution of various media data, or a plurality of reproducing resources for reproducing various media data.

2. Description of the Related Art

Hitherto, for reproducing various media data such as sound, still images, and moving images on a client apparatus such as a personal computer, it has been common to have a plurality of hard device resources such as hard tone generators, and software resources such as soft tone generators, drivers, reproduction applications and plug-ins (hereinafter these resources will be referred to collectively as “reproducing resources”), and to use only some out of these in actual reproduction. For example, if there are a built-in soft tone generator and a connected external tone generator as reproducing resources for reproducing musical tone data, reproduction is carried out using one of these tone generators selectively. The selection of the reproducing resource can be carried out by a user as desired.

However, in recent years, there has been a diversification of media data formats, and for example as with musical tone data such as MIDI data, there are cases in which even if basic parts are the same, with regard to details, the formats and definitions vary according to the data provider. To cope with this, various reproduction applications and so on are provided, and it is often the case that a client apparatus possesses a large number of reproducing resources that are for the same use but differ with regard to functions or version.

A user having little knowledge may not know which reproduction application is the most suitable for a particular media data format, and hence it becomes that reproduction is carried out using a reproducing resource that is active in accordance with a default setting or a setting that the user has made through his/her own judgement, and if the reproducing resource is not suitable for the media data, optimum reproduction cannot be expected. Moreover, there are cases in which even though there is a reproducing resource having higher capabilities, because this has not been selected, reproduction cannot be carried out with adequate sound quality. Furthermore, it is often the case that once the setting of the reproducing resource has been carried out, the setting is subsequently not changed at all. Consequently, there have been cases that the originally possessed performance level of the media data is not adequately realized.

This is the case not only for reproduction applications, but also for various other reproducing resources such as hard devices and drivers. Moreover, there are not only cases in which optimum quality reproduction cannot be carried out due to the relationship between the media data and a reproducing resource, but there are also cases in which optimum quality reproduction cannot be carried out due to a problem of compatibility amongst a plurality of reproducing resources that are together involved in the reproduction. Furthermore, in the case that media data is distributed by a server apparatus, the state of setting of the reproduction environment at a client apparatus is unknown on the server apparatus side, and hence the server apparatus usually carries out distribution of data without distinguishing between different reproduction environments; a situation like that described above thus also arises in the case that a client apparatus acquires data from a server apparatus via a network.

### SUMMARY OF THE INVENTION

It is an object of the present invention to provide a server apparatus, a client apparatus, a contents distributing system, a contents distributing program, and an information processing program, according to which the client apparatus can be aware of recommended reproducing resource settings, and hence an environment enabling optimum reproduction can easily be obtained even if a user has little knowledge.

To attain the above object, the present invention provides a server apparatus comprising a setting information receiving device that receives, via a network, from at least one client apparatus that is able to selectively use a plurality of reproducing resources for reproducing media data, reproduction environment setting information indicative of a reproducing resource setting state in the client apparatus, a recommendation information acquiring device that acquires recommendation information for causing awareness of a recommended reproducing resource setting state, based on the reproduction environment setting information received by the setting information receiving device, and a recommendation information sending device that sends the recommendation information acquired by the recommendation information acquiring device to the client apparatus that sent the reproduction environment setting information.

According to this arrangement, a client apparatus can be made aware of recommended reproducing resource settings, and can thus be encouraged to carry out setting changing for optimum reproduction. For example, at the client apparatus, changing to the optimum settings can be carried out manually, or automatic switching can be carried out, whereby an environment enabling optimum reproduction can easily be obtained even if a user has little knowledge.

Preferably, the recommendation information acquiring device acquires, from a recommendation information table in which recommendation information is registered in advance for each of the reproducing resources, recommendation information corresponding to the reproduction environment setting information received by the setting information receiving device.

To attain the above object, the present invention provides a server apparatus that distributes contents to at least one client apparatus that is able to selectively use a plurality of reproducing resources for reproducing media data and is connected to the server apparatus via a network, comprising a setting information receiving device that receives, via the network, from the client apparatus, reproduction environment setting information indicative of a reproducing resource setting state in the client apparatus, a contents selecting device that selects an item of contents to be distributed from out of a plurality of items of contents for distribution, based on the reproduction environment setting information received by the setting information receiving device, and a contents sending device that sends the item of contents selected by the contents selecting device to the client apparatus that sent the reproduction environment setting information.

According to this arrangement, contents that are optimum for the reproduction environment of a client apparatus can be selectively distributed to the client apparatus.

More preferably, the contents selecting device acquires, from a management database in which reproduction environment setting information and contents types are made to correspond to one another, a contents type suited to the received reproduction environment setting information, and selects an item of contents corresponding to the acquired contents type as the item of contents to be distributed.

Moreover, preferably, the server apparatus according to the present invention further comprises a terminal information receiving device that receives terminal information of the client apparatus, and wherein the contents selecting device acquires, from a management database in which reproduction environment setting information received by the setting information receiving device, terminal information acquired in advance, and contents types are made to correspond to one another, a contents type suited to reproduction environment setting information corresponding to the terminal information received by the terminal information receiving device, and selects an item of contents corresponding to the acquired contents type as the item of contents to be distributed.

To attain the above object, the present invention provides a client apparatus that is able to selectively use a plurality of reproducing resources for reproducing media data, comprising a setting information creating device that creates reproduction environment setting information indicative of a reproducing resource setting state in the client apparatus, and a recommendation information acquiring device that acquires, from a recommendation information table in which recommendation information is registered in advance for each of the reproducing resources, recommendation information corresponding to the reproduction environment setting information created by the setting information creating device, as recommendation information for causing awareness of a recommended reproducing resource setting state.

According to this arrangement, the client apparatus can become aware of recommended reproducing resource settings, and can thus find out a form of setting changing for optimum reproduction.

Preferably, the client apparatus according to the present invention further comprises at least one device of the group consisting of a display device that displays the recommendation information acquired by the recommendation information acquiring device, and an automatic changing device that automatically changes reproducing resource settings based on the recommendation information acquired by the recommendation information acquiring device.

According to this arrangement, changing to the optimum settings can be carried out manually in accordance with display, or automatic switching can be carried out, whereby an environment enabling optimum reproduction can easily be obtained even if a user has little knowledge.

To attain the above object, the present invention provides a contents distributing system comprising a network, at least one client apparatus that is able to selectively use a plurality of reproducing resources for reproducing media data, and a server apparatus connected to the client apparatus via the network, for distributing contents to the client apparatus, wherein the client apparatus comprises a setting information creating device that creates reproduction environment setting information indicative of a reproducing resource setting state in the client apparatus, a setting information sending device that sends the reproduction environment setting information created by the setting information creating device to the server apparatus, and a recommendation information receiving device that receives recommendation information sent from the server apparatus, for causing awareness of a recommended reproducing resource setting state, and wherein the server apparatus comprises a setting information receiving device that receives the reproduction environment setting information sent by the setting information sending device of the client apparatus, a recommendation information acquiring device that acquires the recommendation information based on the reproduction environment setting information received by the setting information receiving device, and a recommendation information sending device that sends the recommendation information acquired by the recommendation information acquiring device to the client apparatus that sent the reproduction environment setting information.

According to this arrangement, a client apparatus can become aware of recommended reproducing resource settings, and changing to optimum settings can be carried out manually, or automatic switching can be carried out, whereby an environment enabling optimum reproduction can easily be obtained even if a user has little knowledge.

Preferably, the recommendation information acquiring device of the server apparatus acquires, from a recommendation information table in which recommendation information is registered in advance for each of the reproducing resources, recommendation information corresponding to the reproduction environment setting information received by the setting information receiving device.

To attain the above object, the present invention provides a contents distributing system comprising a network, at least one client apparatus that is able to selectively use a plurality of reproducing resources for reproducing media data, and a server apparatus connected to the client apparatus via the network, for distributing contents to the client apparatus, wherein the client apparatus comprises a setting information creating device that creates reproduction environment setting information indicative of a reproducing resource setting state in the client apparatus, a setting information sending device that sends the reproduction environment setting information created by the setting information creating device to the server apparatus, and a contents receiving device that receives contents distributed from the server apparatus, and wherein the server apparatus comprises a setting information receiving device that receives the reproduction environment setting information sent by the setting information sending device of the client apparatus, a contents selecting device that selects an item of contents to be distributed from out of a plurality of items of contents for distribution, based on the reproduction environment setting information received by the setting information receiving device, and a contents sending device that sends the item of contents selected by the contents selecting device to the client apparatus that sent the reproduction environment setting information.

According to this arrangement, contents that are optimum for the reproduction environment of a client apparatus can be selectively distributed to the client apparatus.

Preferably, the contents selecting device acquires, from a management database in which reproduction environment setting information and contents types are made to correspond to one another, a contents type suited to the received reproduction environment setting information, and selects an item of contents corresponding to the acquired contents type as the item of contents to be distributed.

Moreover, preferably, the server apparatus further comprises a terminal information receiving device that receives terminal information of the client apparatus, and wherein the contents selecting device acquires, from a management database in which reproduction environment setting information received by the setting information receiving device, terminal information acquired in advance, and contents types are made to correspond to one another, a contents type suited to reproduction environment setting information corresponding to the terminal information received by the terminal information receiving device, and selects an item of contents corresponding to the acquired contents type as the item of contents to be distributed.

To attain the above object, the present invention provides a contents distributing program executed by a computer in a server apparatus, comprising a setting information receiving module for receiving, via a network, from at least one client apparatus that is able to selectively use a plurality of reproducing resources for reproducing media data, reproduction environment setting information indicative of a reproducing resource setting state in the client apparatus, a recommendation information acquiring module for acquiring recommendation information for causing awareness of a recommended reproducing resource setting state, based on the reproduction environment setting information received by the setting information receiving module, and a recommendation information sending module for sending the recommendation information acquired by the recommendation information acquiring module to the client apparatus that sent the reproduction environment setting information.

To attain the above object, the present invention provides a contents distributing program executed by a computer in a server apparatus that distributes contents to at least one client apparatus that is able to selectively use a plurality of reproducing resources for reproducing media data and is connected to the server apparatus via a network, comprising a setting information receiving module for receiving, via the network, from the client apparatus, reproduction environment setting information indicative of a reproducing resource setting state in the client apparatus, a contents selecting module for selecting an item of contents to be distributed from out of a plurality of items of contents for distribution, based on the reproduction environment setting information received by the setting information receiving module, and a contents sending module for sending the item of contents selected by the contents selecting module to the client apparatus that sent the reproduction environment setting information.

To attain the above object, the present invention provides an information processing program executed by a computer in an information processing apparatus that is able to selectively use a plurality of reproducing resources for reproducing media data, comprising a setting information creating module for creating reproduction environment setting information indicative of a reproducing resource setting state in the information processing apparatus, and a recommendation information acquiring module for acquiring, from a recommendation information table in which recommendation information is registered in advance for each of the reproducing resources, recommendation information corresponding to the reproduction environment setting information created by the setting information creating module, as recommendation information for causing awareness of a recommended reproducing resource setting state.

Moreover, the present invention may also be constituted by a computer-readable storage medium storing the contents distributing program or information processing program described above.

The media data reproduced by the reproducing resources includes at least one of sound, still images, and moving images, and the reproducing resources include at least one of devices, drivers, reproduction applications, and operating systems for reproducing such media data. For example, reproducing resources for reproducing musical tone data include built-in soft tone generators, built-in hard tone generators, external tone generators, drivers for each of these tone generators, reproduction applications, and so on; with regard to software resources, it is preferable to handle different versions or the like of the same software resource as being different reproducing resources.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the overall arrangement of a contents distributing system according to a first embodiment of the present invention;

FIGS. 2A and 2B is a flowchart showing a main process carried out by a client apparatus in the first embodiment;

FIG. 3 is a flowchart showing a resource testing process carried out in step S109 in FIGS. 2A and 2B, and a flowchart showing a corresponding resource testing corresponding process carried out by a server apparatus, with the two flowcharts being shown to correspond to one another;

FIG. 4 is a view showing an example of a management database managed by the server apparatus;

FIG. 5 is a view showing an example of a contents type table held by the server apparatus;

FIG. 6 is a view showing an example of a message table;

FIG. 7 is a view showing an example of contents of message data;

FIG. 8 is a flowchart showing a contents receiving process carried out in step S108 in FIGS. 2A and 2B, and a flowchart of a corresponding contents distributing process carried out by the server apparatus, with the two flowcharts being shown to correspond to one another;

FIG. 9 is a view showing flowcharts of the contents receiving process and the contents distributing process that are a continuation of the flowcharts shown in FIG. 8; and

FIG. 10 is a flowchart showing a resource testing process carried out in step S109 in FIGS. 2A and 2B, according to a second embodiment of the present invention.

### DETAILED DESCRIPTION OF THE PREFERRED EMBODIMENTS

The present invention will now be described in detail with reference to the drawings showing preferred embodiments thereof.

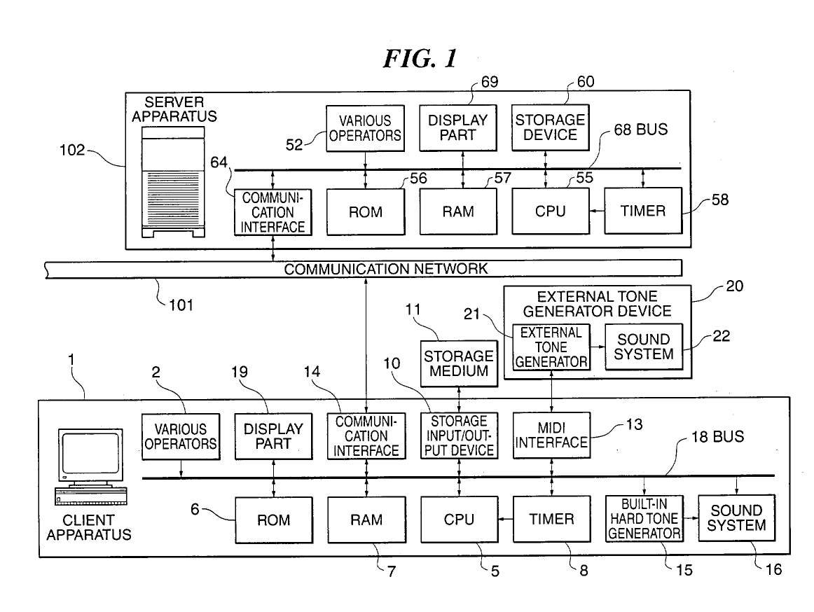

FIG. 1 is a block diagram showing the overall arrangement of a contents distributing system according to a first embodiment of the present invention. The contents distributing system is constructed such that a server apparatus 102 and a client apparatus 1 (information processing apparatus) are connected together via a communication network for communication with one another. The server apparatus 102 is implemented by a server computer and provides a contents data distribution service, and it should be noted that although only one server apparatus 102 is shown in the present example, there may be a plurality of such server apparatuses 102 in the distributing system. The client apparatus 1 is used by a user as a client side apparatus with regard to the distribution service; the client apparatus 1 is implemented by, for example, a personal computer or an electronic musical instrument and serves as an electronic terminal apparatus. Again, although only one client apparatus 1 is shown in the present example, it should be noted that there may be a plurality of such client apparatuses 1 in the distributing system, each having a similar arrangement.

The client apparatus 1 is comprised of various operators 2, a ROM 6, a RAM 7, a timer 8, a storage input/output apparatus 10, a MIDI interface 13, a communication interface 14 (setting information sending apparatus, recommendation information receiving apparatus, contents receiving apparatus), a built-in hard tone generator 15, a sound system 16, a display device 19, and a CPU 5 (setting information creating apparatus, recommendation information acquiring apparatus), to which the above components are connected via a bus 18.

The CPU 5 carries out control of the entire client apparatus 1. The ROM 6 stores an OS (operating system), and also control programs executed by the CPU 5, various table data, and so on. The RAM 7 temporarily stores various inputted information such as text data, various flags, various registers, computation results, and so on. The timer 8 is connected to the CPU 5, and clocks interrupt times for timer interrupt processing and various other times.

The various operators 2 are comprised of a plurality of switches and so on for inputting various information. The display device 19 is comprised of an LCD (Liquid Crystal Display) or the like, and displays the state of the distribution service and so on, information relating to application execution, information relating to various settings, and so on. The communication interface 14 connects the client apparatus 1 to the server apparatus 102 via the communication network 101, which is the Internet or the like, to enable transmission and reception of data therebetween.

The storage input/output apparatus 10 is comprised of any of various drives that drive a storage medium 11 such as a hard disk, a floppy (registered trademark) disk, or an MO. The above-mentioned control programs, and also various other programs and various data can be stored on the storage medium 11. It should be noted that the storage medium 11 may be a built-in hard disk. Various software such as reproduction applications for reproducing various media data such as sound, still images, and moving images, device driver programs such as tone generator drivers, plug-ins, and soft synthesizers that function as built-in soft tone generators, are also stored on the storage medium 11. These may also be stored on the ROM 6 or the RAM 7. Moreover, it should be noted that, although only one storage input/output apparatus 10 and one storage medium 11 are shown in the present example, there may be a plurality of storage input/output apparatuses 10 and a plurality of storage media 11.

The built-in hard tone generator 15 converts musical performance signals into musical tone signals. The sound system 16 applies various effects to musical tone signals inputted to the sound system 16 from the built-in hard tone generator 15, thus converting the musical tone signals into sound. In the case that a soft synthesizer is used, musical tone signals that have been converted from MIDI (Musical Instrument Digital Interface) signals are inputted to the sound system 16 via the bus 18, and the sound system 16 converts these musical tone signals into sound through D/A conversion.

Moreover, the MIDI interface 13 outputs and inputs MIDI signals to and from an external tone generator device 20, which is comprised of an external tone generator 21 and a sound system 22. The external tone generator 21 converts MIDI signals into musical tone signals, and the sound system 22 applies various effects to musical tone signals inputted to the sound system 22 from the external tone generator 21, thus converting the musical tone signals into sound.

For reproducing media data, in addition to software resources such as reproduction applications as described above, there are also hard resources, and these resources will hereinafter be referred to collectively as “reproducing resources”. The hard resources include, for example, the built-in hard tone generator 15, the sound system 16, the external tone generator 21 and the sound system 22 of the external tone generator device 20, the display device 19, and so on. It should be noted that there may exist a plurality of reproducing resources able to reproduce the same media data, for example the built-in hard tone generator 15, a built-in soft tone generator, and the external tone generator 21, or first to third reproduction applications, and between these the provider or maker may differ, or the software version may differ, and hence the functions may differ. Generally, in the case that there are a plurality of reproducing resources competing for reproduction of the same kind of media data, one of the reproducing resources is set to be active, and thus operates. The active resource is set by default, or can be selected by a user as desired. It should be noted that the reproducing resources include resources for streaming reproduction.

The server apparatus 102 is comprised of various operators 52, a ROM 56, a RAM 57, a timer 58, a storage apparatus 60, a communication interface 64 (setting information receiving apparatus, recommendation information sending apparatus, contents sending apparatus, terminal information receiving apparatus), a display part 69, and a CPU 55 (recommendation information acquiring apparatus, contents selecting apparatus) to which the above components are connected via a bus 68. Databases of contents for distribution, various tables and so on as described later are also stored in the storage apparatus 60. Moreover, programs executed by the CPU 55 are stored in the ROM 56 or the storage apparatus 60. Other elements have a similar arrangement to the corresponding elements of the client apparatus 1.

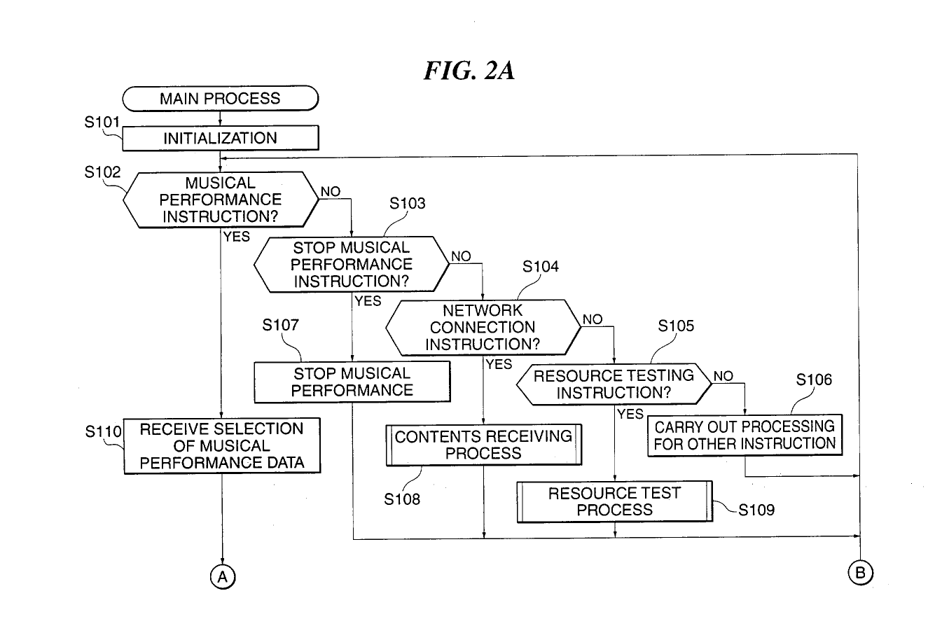

FIGS. 2A and 2B is a flowchart showing a main process carried out by the client apparatus in the present embodiment. It should be noted that, although in the present embodiment musical performance data is given as an example of the media data, the same kind of processing can also be applied to other media data such as still images or moving images.

First, initialization is carried out, specifically execution of a predetermined program is commenced, initialization setting is carried out by clearing the RAM 7 and so on (step S101). Then, operations of the various operators 2 are monitored through an interrupt process, not shown, and processing is carried out in accordance with these operations. Specifically, it is determined whether or not such an operation is an instruction for musical performance (step S102). If the operation is not an instruction for musical performance, it is determined whether or not the operation is an instruction for musical performance stop (step S103). If the operation is not an instruction for musical performance stop, it is determined whether or not the operation is an instruction for network connection (step S104). If the operation is not an instruction for network connection, it is determined whether or not the operation is an instruction for resource testing (step S105). If the operation is not an instruction for resource testing, processing for another instruction is carried out (step S106), and then the process returns to the process returns to step S102.

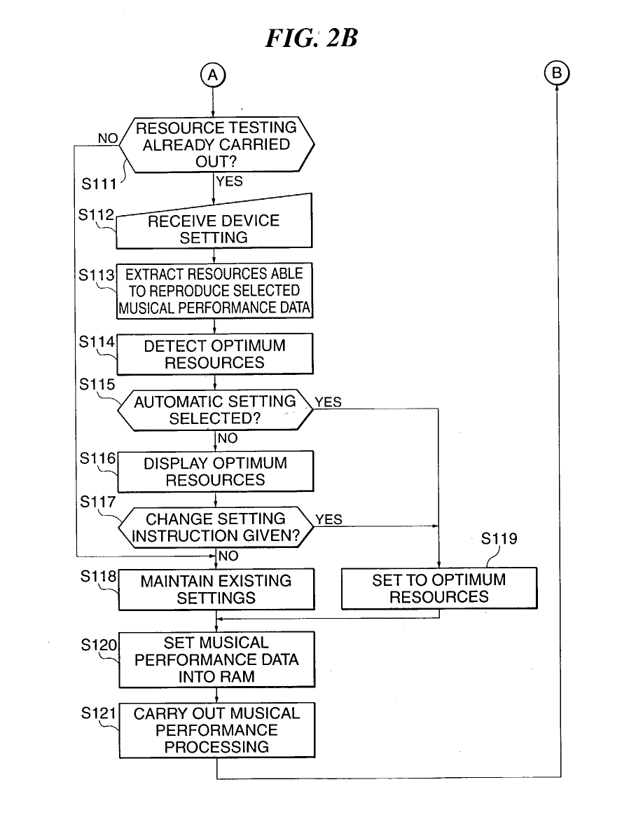

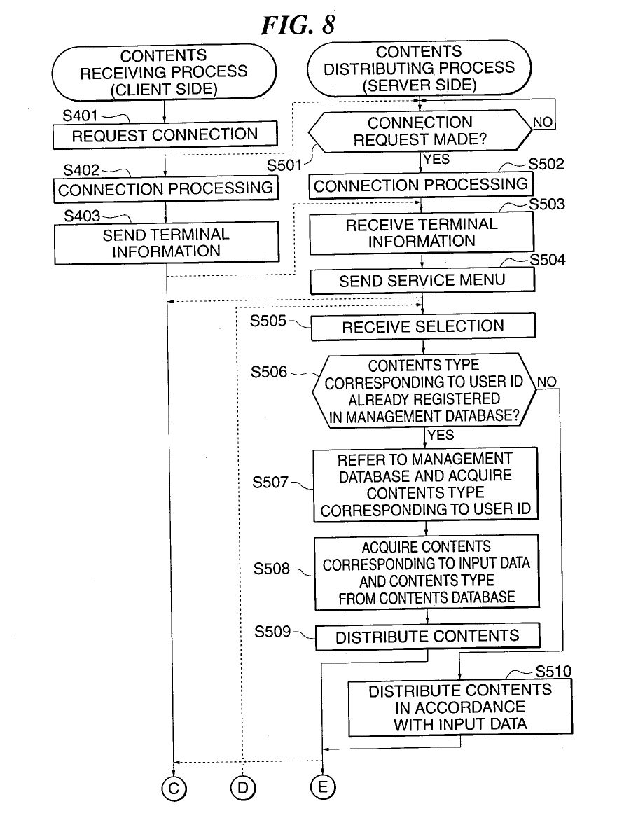

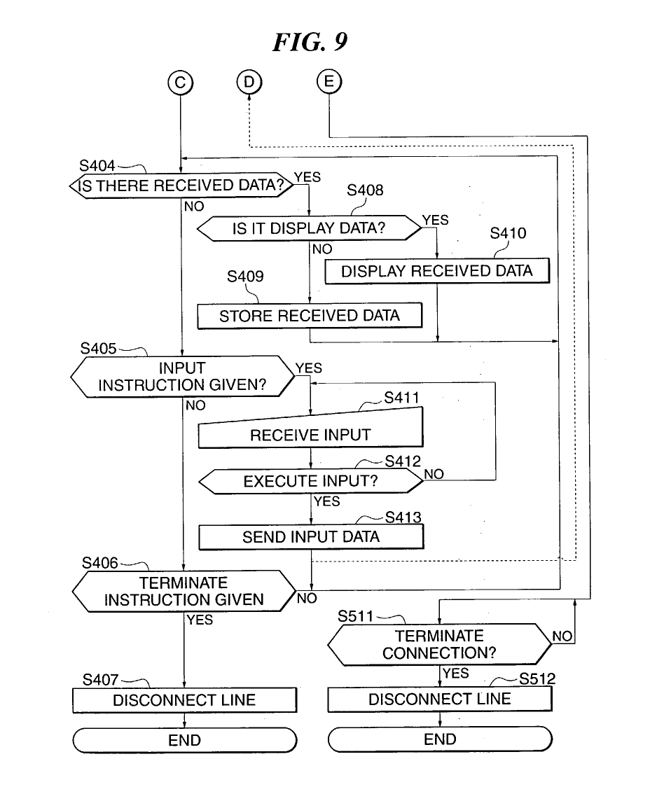

In the case that the result of the determination at step S103 is that the operation is an instruction for musical performance stop, musical performance is stopped (step S107), and then the process returns to the process returns to step S102. If the result of the determination in step S104 is that the operation is an instruction for network connection, a contents receiving process as shown in FIGS. 8 and 9, described later, is carried out (step S108), and then the process returns to step S102. If the result of the determination in step S105 is that the operation is an instruction for resource testing, a resource testing process as shown in FIG. 3, described later, is carried out (step S109), and then the process returns to step S102.

In the case that the result of the determination in step S102 is that the operation is an instruction for musical performance, then selection of musical performance data is received from a user (step S110). Data that has been received through the contents receiving process of step S108 and stored is included under this musical performance data. Next, it is determined whether or not resource testing has been carried out (step Sill). This determination is carried out, for example, by referring to an execution completion flag that is set to “1” when the a resource testing process of step S109 has been carried out. Description of the processing of setting the execution completion flag is omitted.

In the case that the result of the determination in step S111 is that resource testing has not yet been carried out, the process proceeds to step S118, and reproducing resource settings are left as is. Specifically, for the media data in question, the setting state with regard to which out of the various reproducing resources are made to be active is not changed, but rather is maintained as is. Subsequently, the process proceeds to step S120.

On the other hand, if the result of the determination in step S111 is that resource testing has been carried out, receiving of a device setting from the user is carried out (step S112). In this device setting, setting can be carried out as to whether setting of the optimum reproducing resources is carried out automatically or manually.

Next, all of the reproducing resources that are able to reproduce the selected musical performance data are extracted (step S113). Here, all of the reproducing resources, including inactive reproducing resources, are extracted for each type of reproducing resource required. For example, all of the reproducing resources that are reproduction applications are extracted, all of the reproducing resources that are drivers are extracted, and so on; with regard to tone generators, the built-in hard tone generator 15, the external tone generator 21, and built-in soft tone generators are extracted. Next, the optimum reproducing resource is detected for each type of reproducing resource required (step S114). This detection is carried out based on message data MSG (recommendation information) in a “test results file”, described later; the format of the musical performance data, the capabilities of the CPU 5, and also the compatibility between the respective reproducing resources, are all considered, and a combination of reproducing resources having the highest degree of suitability is detected. A description of the message data MSG will be given later.

Next, it is determined whether or not automatic setting was selected in step S112 (step S115), and if the result of the determination is that automatic setting was selected, corresponding ones of the reproducing resources extracted above are set to the detected optimum reproducing resources so that a combination of the optimum reproducing resources is obtained (step S119), and then the process proceeds to step S120. On the other hand, if automatic setting was not selected, the optimum reproducing resources detected above are displayed on a screen as recommended settings (step S116). At this time, differences to the currently set reproducing resources and so on are displayed, and a setting change receiving screen is also displayed.

Next, at the setting change receiving screen, it is determined whether or not there has been an instruction for setting change (step S117), and if there has not been an instruction for setting change, the process proceeds to step S118 and the existing settings are maintained, whereas if there has been an instruction for setting change, step S119 described above is carried out, and then the process proceeds to step S120.

In step S120, the selected musical performance data is set into the RAM 7, and then musical performance processing is carried out using the currently set reproducing resources (step S121). For example, if the built-in hard tone generator 15 has been set to be active as a tone generator, the musical performance data is converted into musical tone signals by the built-in hard tone generator 15, and then required effects are applied to the musical tone signals by the sound system 16, thus converting the musical tone signals into sound, which is outputted from speakers, not shown. After that, the process returns to step S102.

FIG. 3 is a flowchart showing the a resource testing process that is carried out in step S109 in FIGS. 2A and 2B, and a flowchart showing a corresponding resource testing corresponding process that is carried out on the server apparatus 102 side, with the two flowcharts being shown to correspond to one another. Here, in carrying out the present processes, it is assumed that a “user registration process” in which the client apparatus 1 sends a model ID, a device ID, and a user ID to the server apparatus 102, and these are registered and managed by the server apparatus 102 has already been completed for each client apparatus 1. Here, the model ID and the device ID are information that is unique to the client apparatus 1 in question. The model ID is information indicative of the classification, model, version and so on of the client apparatus 1 in question, and the device ID is a character string or the like. The user ID is information that is unique to each user of the client apparatus 1 and is for identifying that user.

In the processing shown in FIG. 3, first, on the client apparatus 1 side, communication line connection processing is carried out, i.e. connection to the server apparatus 102 via the communication network 101 is established (step S201). Next, the reproduction environment of the client apparatus 1 in question, i.e. the state of setting of reproducing resources for media data (e.g. musical performance data) is inspected (step S202), and an “environment profile” (hereinafter referred to as the “reproduction environment setting information EP”) indicative of this reproducing resource setting state is created (step S203). The created reproduction environment setting information EP is then sent to the server apparatus 102 along with the user ID (step S204).

On the server apparatus 102 side, processing is carried out in parallel to the processing described above; first, connection to the client apparatus 1 via the communication network 101 is established through communication line connection processing (step S301), and then the reproduction environment setting information EP and the user ID sent from the client apparatus 1 are received (step S302), and are registered in a management database (step S303).

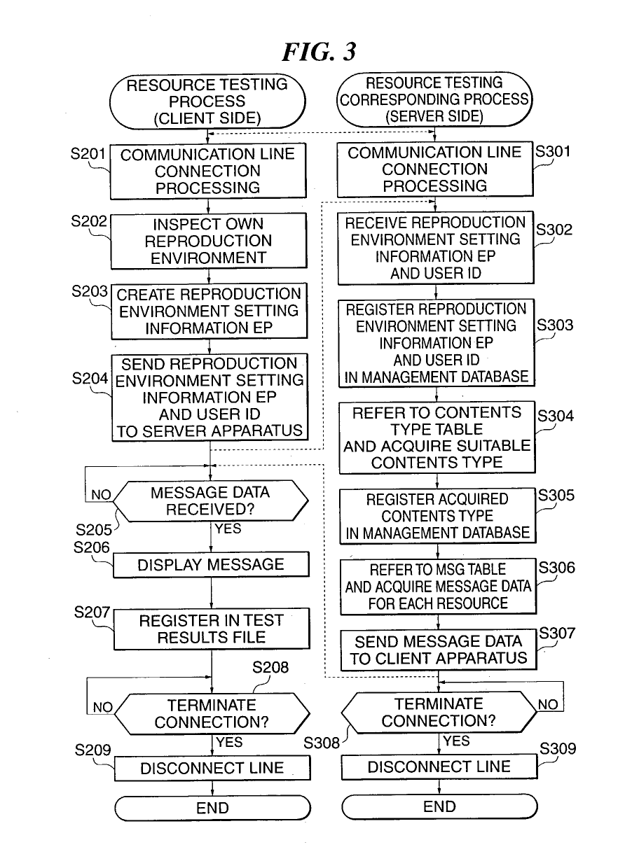

FIG. 4 is a view showing an example of the management database managed by the server apparatus 102. In this management database, each user ID, the received reproduction environment setting information EP for that user, and a contents type, described below, for that user, are registered so as to correspond to one another. The user ID registered is acquired by the server apparatus 102 during user registration. Here it is assumed that for the currently connected user, at the stage of step S303, the contents type has not yet been registered.

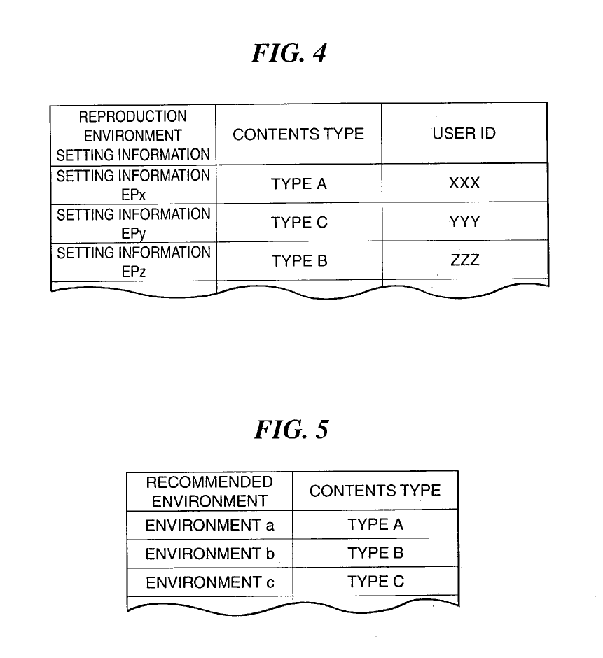

FIG. 5 is a view showing an example of a contents type table held by the server apparatus 102. As shown in FIG. 5, different contents types (A, B, C, . . . ) are registered in correspondence with recommended environments (a, b, c, . . . ). As each recommended environment, a combination of various reproducing resources such as an operating system, a reproduction application, and a device is determined in advance.

Returning to FIG. 3, in the next step S304, the contents type table (see FIG. 5) is referred to, and a contents type suited to the received reproduction environment setting information EP is acquired. The judgement here is carried out in an overall way looking at the combination of reproducing resources determined by the reproduction environment setting information EP, and a contents type of the highest level, i.e. the most suited contents type, within a scope in which good reproduction is possible with that combination is selected. There are a plurality of types of reproducing resource, and hence in the case for example that the functions of one or more of the reproducing resources are markedly poor (e.g. the version(s) is/are old), a contents type of a low level is selected in accordance with this/these reproducing resource(s) having markedly poor functions. Next, in step S305, the acquired contents type is registered in the management database, where it is made to correspond to the user ID of the user in question (see FIG. 4).

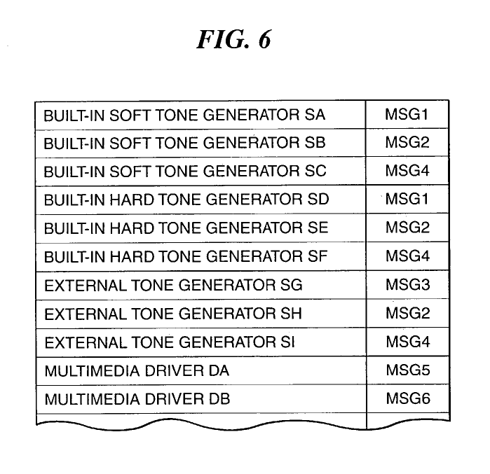

FIG. 6 is a view showing an example of a message table (hereinafter referred to as the “MSG table”) (recommendation information table). The MSG table has registered therein message data MSG containing messages corresponding to each of the reproducing resources, and is held by the server apparatus 102. It is preferable for the registered reproducing resources to include all reproducing resources that could be possessed by the client apparatus 1, although in FIG. 6 only tone generators and drivers are given as examples.

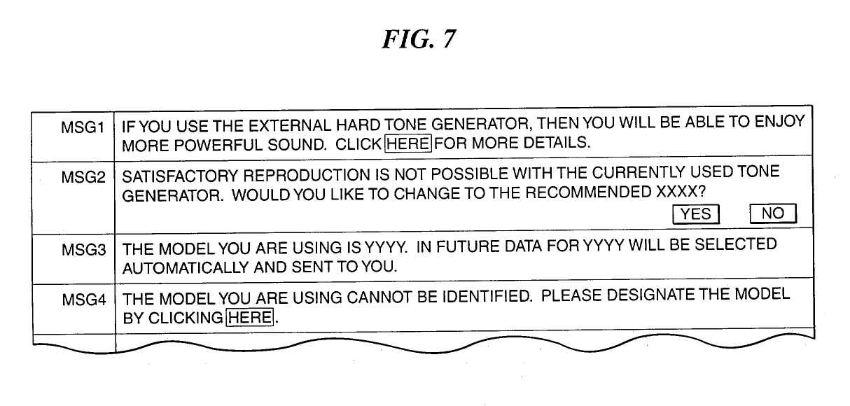

FIG. 7 is a view showing an example of the contents of the message data MSG. The message data MSG contains recommendation information for making the user aware of a recommended reproducing resource setting state, and related information. For example, as shown in FIG. 7, messages recommending a more suitable reproducing resource with regard to the current reproducing resource setting and encouraging the user to change to this reproducing resource, messages indicating the procedure for carrying out a changing operation or purchasing software, messages saying that contents data will be sent in accordance with the current setting, and related messages are displayed. The message data MSG is constituted using HTML or the like, whereby access to a changing operation or the like can be made to be easy. Moreover, the message data MSG may contain messages other than those shown in the example of FIG. 7, control data, and so on.

Returning to FIG. 3, in the next step S306, the MSG table is referred to, message data MSG is acquired for each reproducing resource determined by the reproduction environment setting information EP, and then the acquired message data MSG is sent back to the client apparatus 1 (step S307). Next, it is determined whether or not termination of the connection has been requested (step S308), and connection is maintained until such a request is made; once termination of the connection has been requested, communication line disconnection processing is carried out (step S309). The resource testing corresponding process is then terminated.

Moving back to the client apparatus 1 side, in step S205, it is determined whether or not message data MSG has been received from the server apparatus 102, and this is repeated until message data MSG is received; once message data MSG has been received, a message is displayed on a screen in accordance with the message data MSG (step S206). The form of the display is, for example, as shown in FIG. 7.

Next, the results of resource testing are registered in a test results file (step S207). This test results file contains, for example, the reproduction environment setting information EP for the client apparatus 1 in question and the received message data MSG. It should be noted that a step of setting a reproducing resource may be provided immediately after step S206. That is, the user is able to become aware of the optimum reproducing resources through the message data MSG, and hence an arrangement may be adopted in which changing of the settings is carried out manually by the user in accordance with the message data MSG, or alternatively an arrangement may be adopted in which the user clicks on “YES”, “HERE” or the like in the displayed message data MSG (see FIG. 7), and then follows guidance to change the reproducing resource settings. Moreover, if necessary, an arrangement may be adopted in which downloading of a reproducing resource or resources for purchase, installation, and setting to make active are carried out. If changing of the settings is carried out, the reproduction environment setting information EP should be newly created after the changing of the settings, and registered in the test results file.

Next, in step S208, it is determined whether or not an instruction for connection termination has been given, and connection is maintained until such an instruction is given; once an instruction for connection termination has been given, communication line disconnection processing is carried out (step S209). The resource testing process is then terminated.

According to the process of FIG. 3, the client apparatus 1 can be made aware of recommended reproducing resource settings, and hence the client apparatus 1 can be encouraged to carry out setting changing for optimum reproduction.

FIGS. 8 and 9 are views showing a flowchart of the a contents receiving process that is carried out in step S108 in FIGS. 2A and 2B, and a flowchart of a corresponding contents distributing process that is carried out by the server apparatus 102, with the two flowcharts being shown to correspond to one another.

First, on the client apparatus 1 side, a communication line connection request is made (step S401), and communication line connection processing is carried out, thus establishing connection to the server apparatus 102 via the communication network 101 (step S402), and then terminal information is sent to the server apparatus 102 (step S403). Here, the user ID is sent as the terminal information, but other information relating to the user or the client apparatus 1 may be included. In particular, if the resource testing of FIG. 3 has already been completed, the test results file may be included in the terminal information.

At the server apparatus 102, processing is carried out in parallel to the processing described above; first, it is determined whether or not there has been a communication line connection request from the client apparatus 1 (step S501), and this is repeated until there is such a request; once there has been such a request, connection to the client apparatus 1 via the communication network 101 is established through communication line connection processing (step S502), the terminal information sent from the client apparatus 1 is received (step S503), and after processing such as authentication, a service menu corresponding to the terminal information is sent to the client apparatus 1 in question (step S504). The service menu contains, for example, a list of pieces of music that can be provided.

Next, input data inputted through menu selection or the like (e.g. selection of a piece of music) is received from the client apparatus 1 (step S505), and then it is determined whether or not registration in the management database of a contents type corresponding to the user ID contained in the terminal information (see FIG. 4) has already been carried out (step S506). If the result of the determination is that such registration has already been carried out, the management database is referred to, and the contents type corresponding to the user ID is acquired (step S507), and then contents corresponding to the received input data and the acquired contents type are acquired from a contents database, not shown (step S508). Here, the contents database is a database in which contents for distribution have been stored corresponding to the various contents types; the contents database is stored, for example, in the server apparatus 102.

Next, the acquired contents are distributed to the client apparatus 1 corresponding to the user ID in question (step S509). As a result, contents suited to the reproduction environment of the client apparatus 1 are selectively distributed to that client apparatus 1. Next, the process proceeds to step S511.

On the other hand, if the result of the determination in step S506 is that the registration in the management database of a contents type corresponding to the user ID contained in the terminal information has not yet been carried out, contents are acquired in accordance with the received input data, and are distributed to the client apparatus 1 (step S510). In this case, it becomes such that the data requested through the input data is distributed as it is, regardless of whether or not this data is suited to the reproduction environment of the client apparatus 1. Next, the process proceeds to step S511.

In step S511, it is determined whether or not there has been a connection termination request, and this is repeated until there is such a request; once a connection termination request has been made, communication line disconnection processing is carried out (step S512). The contents distributing program is then terminated.

Moving back to the client apparatus 1 side, in the next step S404, it is determined whether or not there is received data. Here, a service menu and distributed contents sent from the server apparatus 102 are also taken as being such received data. If the result of the determination is that there is received data, it is determined whether or not this received data is display data (step S408), and if the received data is display data, the received data is displayed on a screen (step S410), and then the process returns to step S404, whereas if the received data is not display data, the received data is stored (step S409), and then the process returns to step S404.

If the result of the determination in step S404 is that there is no received data, it is determined whether or not there has been an input instruction for a selection operation or the like by the user using the various operators 2 or the like (step S405), and if there has been such an input instruction, the input (e.g. selection of a piece of music) is received (step S411), and then it is determined whether or not an instruction for executing the input has been given using an “enter” key or the like, not shown (step S412). If the result of the determination is that such an instruction for executing the input has not been given, the process returns to step S411, whereas if an instruction for executing the input has been given, the input data is sent to the server apparatus 102 (step S413), and then the process returns to step S404.

If the result of the determination in step S405 is that there has been no input instruction from the user, it is determined whether or not there has been an instruction for connection termination from the user (step S406), and if there has been no instruction for connection termination, the process returns to step S404, whereas if there has been an instruction for connection termination, communication line disconnection processing is carried out (step S407), whereupon the contents receiving process is terminated.

According to the present embodiment, an arrangement has been adopted in which the server apparatus 102 sends message data MSG back to a client apparatus 1 based on reproduction environment setting information EP acquired from the client apparatus 1. As a result, the server apparatus 102 can make the client apparatus 1 aware of recommended reproducing resource settings, and can thus encourage setting changing for optimum reproduction to be carried out at the client apparatus 1. From the standpoint of the client apparatus 1, the client apparatus 1 looks at the message data MSG, and thus becomes aware of what are the optimum reproducing resource settings, and hence changing to the optimum reproducing resource settings can be carried out manually by a user in accordance with display, or through automatic switching. Furthermore, even when reproducing media data that has already been acquired, it is possible to detect the optimum reproducing resources based on the message data MSG, and set corresponding reproducing resources to be the optimum reproducing resources through automatic setting or the like. Consequently, an environment enabling optimum reproduction can easily be obtained even if the user has little knowledge.

Moreover, an arrangement is adopted in which the server apparatus 102 acquires a contents type suited to the reproduction environment setting information EP, and selectively distributes contents corresponding to this contents type from out of a contents database. As a result, contents that are optimum for the reproduction environment of the client apparatus in question can be selectively distributed. From the standpoint of the client apparatus 1, media data that is suited to the reproducing resource setting state of that client apparatus 1 can be obtained, and hence optimum reproduction such as musical performance can be carried out.

It should be noted that in the above described first embodiment, the various tables, databases and so on described above are stored on the server apparatus 102; however, there is no limitation to this, but rather, for example, an arrangement may be adopted in which the server apparatus 102 is made to function merely as a client-handling server that carries out data exchange with users, the contents database and the management database are stored in advance on other servers, for example the contents database is stored on a storing server and the management database is stored on a client management server, and it is made to be such that the data in the contents database and the management database can be accessed by the client-handling server. Moreover, an arrangement may also be adopted in which distribution of data to a client apparatus is carried out directly from the storing server via a network.

Next, a description will be given of a second embodiment of the present invention.

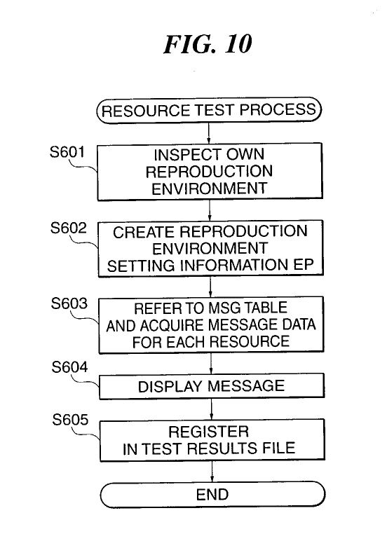

In the first embodiment, an arrangement is adopted in which the message data MSG in the resource testing process is sent back to the client apparatus 1 from the server apparatus 102 in accordance with the reproduction environment setting information EP sent from the client apparatus 1 to the server apparatus 102. However, in the present second embodiment, the MSG table is stored in advance in the client apparatus 1, and the client apparatus 1 carries out the resource testing process alone. A description of the resource testing process in the second embodiment will thus now be given using FIG. 10, instead of FIG. 3 used in the first embodiment. Other than this, the second embodiment is the same as the first embodiment.

FIG. 10 is a flowchart showing the resource testing process that is carried out in step S109 in FIGS. 2A and 2B, according to the second embodiment.

First, in steps S601 and S602, processing like that of steps S202 and S203 in FIG. 3 is carried out, whereby reproduction environment setting information EP is created. Next, an MSG table stored on the storage medium 11 or the like of the client apparatus 1 is referred to, and message data MSG is acquired for each reproducing resource determined in the reproduction environment setting information EP (step S603). Next, as in steps S206 and S207 in FIG. 3, a message is displayed on a screen in accordance with the acquired message data MSG (step S604), and then the results of resource testing are registered in a test results file (step S605), whereupon the resource testing process is terminated.

According to the present embodiment, similar effects to those of the first embodiment can be achieved.

It is to be understood that the object of the present invention can also be attained by supplying a system (a client apparatus 1 and a server apparatus 102) or an apparatus with a storage medium storing program code of software which realizes the functions of either of the above described embodiments of the present invention, and then causing a computer (or CPU, MPU, or the like) of the system or apparatus to read out and execute the program code stored on the storage medium.

In this case, the program code itself read out from the storage medium realizes the functions of the embodiment of the present invention, and thus the storage medium storing the program code constitutes the present invention. Moreover, if the program code is supplied via a transmission medium (e.g. the communication interface 14) or the like, the program code itself constitutes the present invention.

Examples of the storage medium for supplying the program code include a ROM, a floppy (registered trademark) disk, a hard disk, an optical disk, a magnetic-optical disk, a CD-ROM, a CD-R/RW, a DVD-ROM, a DVD-RAM, a DVD-R/RW, a DVD+RW, an NV-RAM, a magnetic tape, and a nonvolatile memory card. Further, the program code can be downloaded via a network. Further, it is to be understood that the functions of the embodiment of the present invention can be realized not only through the computer reading out and executing the program code, but also by causing an operating system or the like running on the computer to perform part or all of the actual operations based on instructions of the program code.

Furthermore, it is to be understood that the functions of either of the above described embodiments of the present invention can also be realized by writing the program code read out from the storage medium into a memory provided on a function expansion board inserted into the computer or in a function expansion unit connected to the computer, and then causing a CPU or the like provided in the function expansion board or in the function expansion unit to perform part or all of the actual operations based on instructions of the program code.

What is claimed is:

1. A server apparatus comprising:
a setting information receiving device that receives, via a network, from at least one client apparatus that is able to selectively use a plurality of reproducing resources for reproducing media data, reproduction environment setting information indicative of a reproducing resource setting state in the client apparatus;
a recommendation information acquiring device that acquires recommendation information for causing awareness of a recommended reproducing resource setting state, based on the reproduction environment setting information received by said setting information receiving device; and
a recommendation information sending device that sends the recommendation information acquired by said recommendation information acquiring device to the client apparatus that sent the reproduction environment setting information.

2. A server apparatus as claimed in claim 1, wherein said recommendation information acquiring device acquires, from a recommendation information table in which recommendation information is registered in advance for each of the reproducing resources, recommendation information corresponding to the reproduction environment setting information received by said setting information receiving device.

3. A server apparatus that distributes contents to at least one client apparatus that is able to selectively use a plurality of reproducing resources for reproducing media data and is connected to the server apparatus via a network, comprising:
a setting information receiving device that receives, via the network, from the client apparatus, reproduction environment setting information indicative of a reproducing resource setting state in the client apparatus;
a contents selecting device that selects an item of contents to be distributed from out of a plurality of items of contents for distribution, based on the reproduction environment setting information received by said setting information receiving device; and
a contents sending device that sends the item of contents selected by said contents selecting device to the client apparatus that sent the reproduction environment setting information.

4. A server apparatus as claimed in claim 3, wherein said contents selecting device acquires, from a management database in which reproduction environment setting information and contents types are made to correspond to one another, a contents type suited to the received reproduction environment setting information, and selects an item of contents corresponding to the acquired contents type as the item of contents to be distributed.

5. A server apparatus as claimed in claim 3, further comprising a terminal information receiving device that receives terminal information of the client apparatus, and wherein said contents selecting device acquires, from a management database in which reproduction environment setting information received by said setting information receiving device, terminal information acquired in advance, and contents types are made to correspond to one another, a contents type suited to reproduction environment setting information corresponding to the terminal information received by said terminal information receiving device, and selects an item of contents corresponding to the acquired contents type as the item of contents to be distributed.

6. A client apparatus that is able to selectively use a plurality of reproducing resources for reproducing media data, comprising:
a setting information creating device that creates reproduction environment setting information indicative of a reproducing resource setting state in the client apparatus; and
a recommendation information acquiring device that acquires, from a recommendation information table in which recommendation information is registered in advance for each of the reproducing resources, recommendation information corresponding to the reproduction environment setting information created by said setting information creating device, as recommendation information for causing awareness of a recommended reproducing resource setting state.

7. A client apparatus as claimed in claim 6, further comprising at least one device of the group consisting of a display device that displays the recommendation information acquired by said recommendation information acquiring device, and an automatic changing device that automatically changes reproducing resource settings based on the recommendation information acquired by said recommendation information acquiring device.

8. A contents distributing system comprising:
a network;
at least one client apparatus that is able to selectively use a plurality of reproducing resources for reproducing media data; and
a server apparatus connected to said client apparatus via said network, for distributing contents to said client apparatus;
wherein said client apparatus comprises:
a setting information creating device that creates reproduction environment setting information indicative of a reproducing resource setting state in said client apparatus;
a setting information sending device that sends the reproduction environment setting information created by said setting information creating device to said server apparatus; and
a recommendation information receiving device that receives recommendation information sent from said server apparatus, for causing awareness of a recommended reproducing resource setting state;
and wherein said server apparatus comprises:
a setting information receiving device that receives the reproduction environment setting information sent by said setting information sending device of said client apparatus;
a recommendation information acquiring device that acquires the recommendation information based on the reproduction environment setting information received by said setting information receiving device; and
a recommendation information sending device that sends the recommendation information acquired by said recommendation information acquiring device to said client apparatus that sent the reproduction environment setting information.

9. A contents distributing system as claimed in claim 8, wherein said recommendation information acquiring device of said server apparatus acquires, from a recommendation information table in which recommendation information is registered in advance for each of the reproducing resources, recommendation information corresponding to the reproduction environment setting information received by said setting information receiving device.

10. A contents distributing system comprising:
a network;
at least one client apparatus that is able to selectively use a plurality of reproducing resources for reproducing media data; and
a server apparatus connected to said client apparatus via said network, for distributing contents to said client apparatus;
wherein said client apparatus comprises:
a setting information creating device that creates reproduction environment setting information indicative of a reproducing resource setting state in said client apparatus;
a setting information sending device that sends the reproduction environment setting information created by said setting information creating device to said server apparatus; and
a contents receiving device that receives contents distributed from said server apparatus;
and wherein said server apparatus comprises:
a setting information receiving device that receives the reproduction environment setting information sent by said setting information sending device of said client apparatus;
a contents selecting device that selects an item of contents to be distributed from out of a plurality of items of contents for distribution, based on the reproduction environment setting information received by said setting information receiving device; and
a contents sending device that sends the item of contents selected by said contents selecting device to said client apparatus that sent the reproduction environment setting information.

11. A contents distributing system as claimed in claim 10, wherein said contents selecting device acquires, from a management database in which reproduction environment setting information and contents types are made to correspond to one another, a contents type suited to the received reproduction environment setting information, and selects an item of contents corresponding to the acquired contents type as the item of contents to be distributed.

12. A contents distributing system as claimed in claim 10, wherein said server apparatus further comprises a terminal information receiving device that receives terminal information of said client apparatus, and wherein said contents selecting device acquires, from a management database in which reproduction environment setting information received by said setting information receiving device, terminal information acquired in advance, and contents types are made to correspond to one another, a contents type suited to reproduction environment setting information corresponding to the terminal information received by said terminal information receiving device, and selects an item of contents corresponding to the acquired contents type as the item of contents to be distributed.

13. A contents distributing program executed by a computer in a server apparatus, comprising:
a setting information receiving module for receiving, via a network, from at least one client apparatus that is able to selectively use a plurality of reproducing resources for reproducing media data, reproduction environment setting information indicative of a reproducing resource setting state in the client apparatus;
a recommendation information acquiring module for acquiring recommendation information for causing awareness of a recommended reproducing resource setting state, based on the reproduction environment setting information received by said setting information receiving module; and
a recommendation information sending module for sending the recommendation information acquired by said recommendation information acquiring module to the client apparatus that sent the reproduction environment setting information.

14. A contents distributing program executed by a computer in a server apparatus that distributes contents to at least one client apparatus that is able to selectively use a plurality of reproducing resources for reproducing media data and is connected to the server apparatus via a network, comprising:
a setting information receiving module for receiving, via the network, from the client apparatus, reproduction environment setting information indicative of a reproducing resource setting state in the client apparatus;
a contents selecting module for selecting an item of contents to be distributed from out of a plurality of items of contents for distribution, based on the reproduction environment setting information received by said setting information receiving module; and
a contents sending module for sending the item of contents selected by said contents selecting module to the client apparatus that sent the reproduction environment setting information.

15. An information processing program executed by a computer in an information processing apparatus that is able to selectively use a plurality of reproducing resources for reproducing media data, comprising:
a setting information creating module for creating reproduction environment setting information indicative of a reproducing resource setting state in the information processing apparatus; and
a recommendation information acquiring module for acquiring, from a recommendation information table in which recommendation information is registered in advance for each of the reproducing resources, recommendation information corresponding to the reproduction environment setting information created by said setting information creating module, as recommendation information for causing awareness of a recommended reproducing resource setting state.
